(19) United States
(12) Patent Application Publication
(10) Pub. No.: US 2026/0266250 A1
(43) Pub. Date: Sep. 10, 2026

(54) LOUVER DESIGN TO MINIMIZE DUST ENTRY IN GENERATOR SETS

(71) Applicant: Cummins Power Generation Inc., Minneapolis, MN (US)

(72) Inventors: Amit Lahariya, Pune (IN); Shrikant Rameshji Tipatle, Pune (IN); Prashant Kumar, Pune (IN)

(73) Assignee: Cummins Power Generation Inc., Minneapolis, MN (US)

(21) Appl. No.: 19/561,132

(22) Filed: Mar. 9, 2026

(30) Foreign Application Priority Data
Mar. 10, 2025 (IN) 202541021434

(51) Int. Cl. F02M 35/10; B01D 45/08

(52) U.S. Cl. CPC F02M 35/10262; B01D 45/08

(57) ABSTRACT

A diesel genset includes an engine configured to provide mechanical power; a generator configured to provide electrical power using the mechanical power using the mechanical power from the engine; an enclosure defining an at least partially enclosed space and a ventilation opening; and a louver assembly disposed at the ventilation opening. The louver assembly further includes a plurality of louvers extending into the enclosed space. Each of the louvers includes a first leg and a second leg and is structured to minimize the entry of dust into the enclosure.

### CROSS-REFERENCE TO RELATED APPLICATIONS

The present application claims the benefit of and priority to Indian Patent Application No. 202541021434 filed Mar. 10, 2025, the disclosure of which is incorporated herein by reference in its entirety.

### FIELD

The present invention relates generally to the field of enclosures for housing engines and generators.

### BACKGROUND

Generator sets (“gensets,”including, for example, diesel gensets) may be employed for physical power production in a variety of applications (e.g., mining applications, etc.). A genset typically includes a diesel engine and an electric power generator coupled to the engine. The engine is structured to mechanically drive the generator, which, in turn, can produce electricity. The engine and the generator may be housed within an enclosure that allows the genset to operate outdoors, and to tolerate environmental extremes of temperature, humidity, and precipitation (e.g., rain, snow, ice, etc.), and other factors.

### SUMMARY

In some embodiments, an enclosure for a genset includes a housing, a plurality of openings, and a plurality of louvers. The housing of the enclosure defines a partially enclosed space. The plurality of openings are formed on a side of the housing. The louvers are coupled to the same side of the housing as the plurality of openings. Each louver includes a first leg and a second leg, the first leg having a vertical upper end and a vertical lower end, the second leg having a vertical upper end and a lower end. The vertical upper end of the second leg is coupled with the vertical upper end of the first leg. The lower end of the second leg is structured to direct air downwards.

In some embodiments, the plurality of openings is defined by the plurality of louvers.

In some embodiments, the enclosure includes a floor, the floor defining the outer portion of the at least partially enclosed space that is away from the generator and the engine.

In some embodiments, each louver includes a plurality of legs, each of the legs including a vertical upper end.

In some embodiments, each louver extends upward at an angle relative to at least one side of the enclosure.

In some embodiments, each louver extends downward at an angle relative to at least one side of the enclosure.

In some embodiments, the plurality of louvers includes a first louver and a second louver below the first louver. A first leg of the first louver extends vertically downward past a first leg of the second louver, restricting airflow passing into the space.

In some embodiments, the number of louvers included in the plurality of louvers corresponds to a target amount of restriction of the airflow by the plurality of louvers.

In some embodiments, the distance between each louver of the plurality of louvers corresponds to a target amount of restriction of the airflow by the plurality of louvers.

In some embodiments, each louver of the plurality of louvers is vertically aligned with the other louvers of the plurality of louvers.

In some embodiments, each louver is partially flush to the enclosure.

In some embodiments, each louver is structured to direct dust downwards towards a floor of the enclosure.

In some embodiments, an airflow system for a genset includes an enclosure, at least one opening, and a louver assembly coupled to the at least one opening. The louver assembly forms multiple airflow paths to deflect airflow into the enclosure.

In some embodiments, the louver assembly includes a first louver and a second louver positioned below the first louver. Each of the first louver and the second louver direct airflow towards the other of the first louver and the second louver.

In some embodiments, the louver assembly creates multiple airflow paths causing dust in the air to settle on a surface of the louver assembly facing outward of the enclosure.

In some embodiments, each louver includes a first leg and a second leg. The first leg is longer than the second leg and positioned outward from the second leg relative to the space.

In some embodiments, a diesel genset includes an engine, a generator, an enclosure, and a plurality of louvers. The engine provides mechanical power. The generator uses the mechanical power from the engine to provide electrical power. The enclosure defines a space and a ventilation opening, the space at least partially enclosed by the enclosure and including an outer portion adjacent to the enclosure and an inner portion inward from the outer portion, the engine and the generator in the inner portion. The plurality of louvers is positioned at the ventilation opening and extending into the enclosed space. Each of the louvers is structured to redirect airflow from a first direction, outside of the enclosed space towards the inner portion of the space and to a surface of one or more of the louvers and/or to the outer portion of the space, causing dust to settle on each louver.

In some embodiments, each louver includes a first and a second leg, and an upper end of the first leg is attached to an upper end of the second leg.

In some embodiments, the surface faces outwards from the enclosure to collect dust redirected by the plurality of louvers.

In some embodiments, the plurality of louvers directs air downwards towards a floor of the enclosure.

It should be appreciated that all combinations of the foregoing concepts and additional concepts are discussed in greater detail below (provided such concepts are not mutually inconsistent) are contemplated as being part of the subject matter disclosed herein. In particular, all claimed subject matter appearing at the end of this disclosure are contemplated as being part of the subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a perspective view of a DG set, according to an exemplary embodiment.

FIG. 2 is a side view through a side wall of the DG set of FIG. 1.

FIG. 3 is a side cross-sectional view of a portion of a louver assembly of the DG set of FIG. 1.

FIG. 4 is a schematic representation of a flow path of the DG set of FIG. 1

FIG. 5 is a perspective view of a portion of the louver assembly of the DG set of FIG. 1.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to methods and devices for minimizing dust entering an enclosure (e.g., DG set enclosure) as a result of ventilation air entering the enclosure. In particular, embodiments described herein relate generally to a louver assembly including multiple louvers disposed proximate to a ventilation air opening of the enclosure. The enclosure typically includes openings to facilitate the exchange of ventilation air between the interior of the enclosure and the environment surrounding the enclosure, which cools internal components during operation. However, the openings also provide a path through which dust and other particles of solid matter in the environment can enter the enclosure. For this reason, enclosures often include deflectors (e.g., louvers, baffles, etc.) in the air intake path to prevent entry of dust into the enclosure. The deflectors often increase restriction along the flow path into the enclosure. Louvers and/or louver assemblies in accordance with the present disclosure can redirect (e.g., deflects, reflects, etc.) air multiple times as it enters the enclosure, towards surfaces configured to collect and direct dust. Each of the louvers defines a flow path, which may be adjusted to optimize air movement restriction within the enclosure.

In some embodiments, the position of the louvers may be adjusted. This can allow for more effective air movement restriction, which causes particles in the air to settle (e.g., fall out of the air). Moreover, the louvers help in providing a surface for the settled particles to be collected on. Advantageously, the collection of dust by the louvers prevents the particles from entering the enclosure. The various concepts introduced above and discussed in greater detail below may be implemented in any of numerous ways, as the described concepts are not limited to any particular manner of implementation. Examples of specific implementations and application are provided primarily for illustrative purposes.

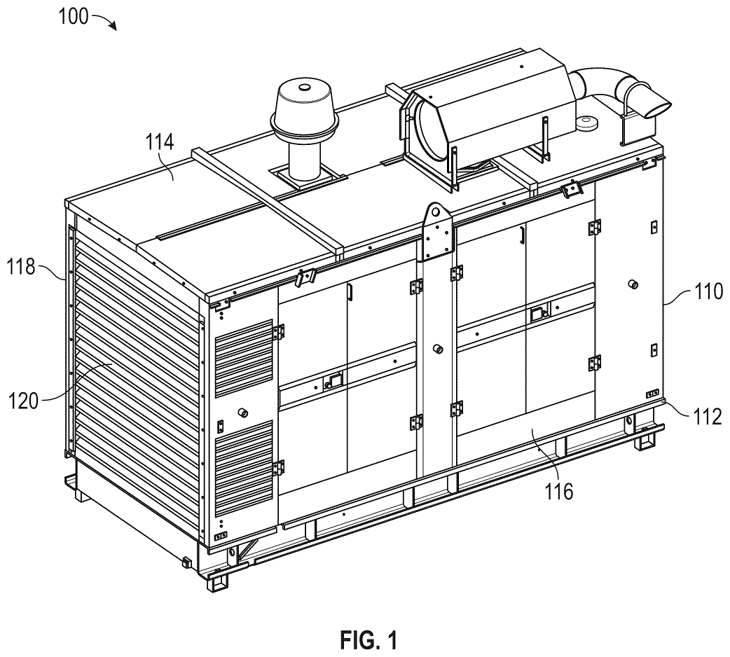

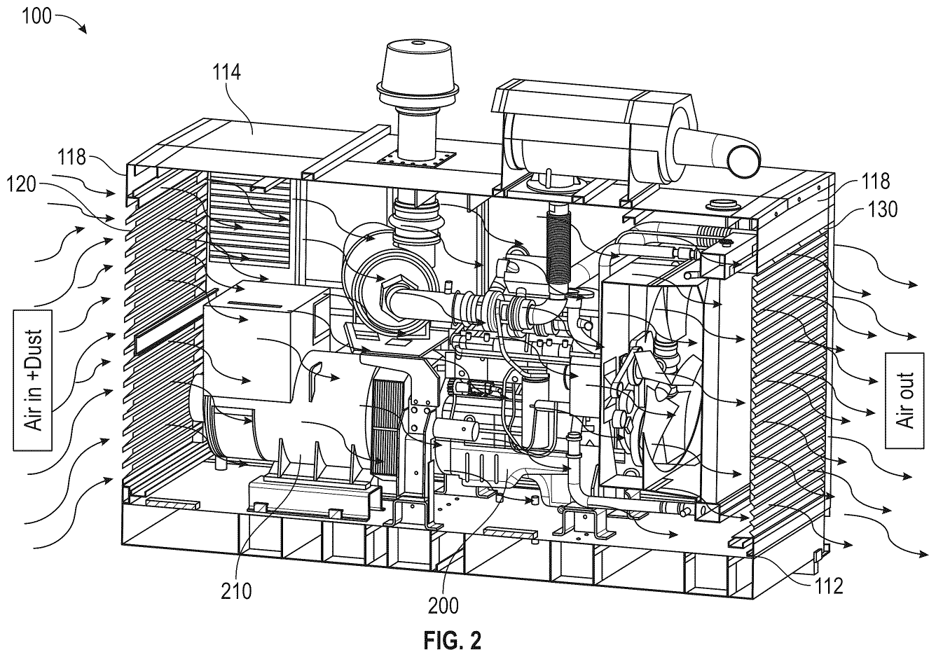

FIG. 1 is a perspective view of a DG set 100, according to an exemplary embodiment. FIG. 2 is a side view through a side wall of the DG set 100. The DG set 100 includes an engine 200, a generator 210, an enclosure 110, and two airflow assemblies. In some embodiments, a different number of airflow assemblies can be provided. According to an exemplary embodiment, the engine 200 is a diesel engine, configured to combust diesel fuel to generate mechanical power. In some other embodiments, the engine 200 can be a gasoline engine, a natural gas engine, a dual fuel engine, a biodiesel engine, an E85 engine, a flex fuel engine, a gas turbine, or another type of internal combustion engine or driver. In various embodiments, the engine 200 can be a high horsepower (HHP) engine capable of providing power in the range of 500 hp to 4,500 hp or more. The generator 210 can be an electric power generator, an alternator, or the like. In one embodiment, the engine 200 is coupled to the generator 210 by, for example, a driveshaft (not shown). In operation, the engine 200 drives the generator 210 to produce electricity (e.g., power). For example, the engine 200 is configured to provide mechanical power, and the generator 210 is configured to provide electrical power using the mechanical power from the engine. Embodiments of the present disclosure are also applicable for various types of prime mover (mechanical, electrical, hydro, and/or fuel cell types) with various power strengths (low, medium, and high horsepower).

As shown in FIGS. 1-2, the enclosure 110 includes end walls (e.g., container walls, sidewalls, etc.) defining an internal volume (e.g., an enclosed space, a hollow region, etc.) for housing the engine 200, the generator 210, and other DG set components. The enclosure 110 defines an at least partially enclosed space and a ventilation opening. The end walls include an enclosure floor 112, an enclosure roof 114, and enclosure side walls 116 arranged in substantially perpendicular orientation relative to the enclosure floor 112 and the enclosure roof 114. The enclosure floor 112 and the enclosure roof 114 are coupled at their lateral edges to edges of the enclosure side walls 116. One or more doors can be provided in one or both of the enclosure side walls 116 to allow an operator of the DG set 100 (e.g., maintenance or repair personnel) to enter the internal volume defined by the enclosure 110 and access the DG set 100. A pair of enclosure end walls 118 are positioned at longitudinal ends of the enclosure 110 and coupled to the corresponding edges of the enclosure floor 112, the enclosure roof 114, and the enclosure side walls 116, so as to seal the enclosure 110 from the surrounding environment. The enclosure floor 112, the enclosure roof 114, the enclosure side walls 116, and the enclosure end walls 118 can be formed from any suitable material, for example, corrugated weathering steel. Furthermore, the enclosure 110 can have the dimensions of a standard ISO container (e.g., a length of about 6.1 meters, 12.2 meters, 14.6 meters, or about 16.2 meters and a height of about 2.59 meters, 2.9 meters, or about 3.2 meters). In other embodiments, the enclosure 110 can include a non-ISO container, for example, any non-standardized ISO container. The enclosure 110 can be formed from flat sheet metal or a non-metallic material (e.g., wood, plastics, reinforced polymers, cement, concrete, fiber glass, carbon fiber, etc.).

In some embodiments, the enclosure 110 can be disposed on the ground. In other embodiments, the enclosure 110 can be mounted on a fuel tank (not shown) that is disposed on the ground, or mounted on skids (not shown) that are disposed on the ground. In other embodiments, the enclosure 110 can be positioned on a rooftop above the ground or another suitable location.

The enclosure 110 is configured to provide airflow therethrough to cool the DG set 100 and provide intake air for the engine 200. As shown in FIGS. 1-2, the enclosure 110 includes ventilation air openings including a ventilation air intake opening containing a louver assembly 120 such that the louver assembly 120 is disposed at the ventilation opening, and a ventilation air outlet opening, shown as outlet assembly 130. In at least one embodiment, each of the louver assembly 120 and the outlet assembly 130 are defined in either of the enclosure end walls 118 and fluidly couple the internal volume of the enclosure 110 with an environment surrounding the enclosure 110. In the embodiment shown in FIGS. 1-2, the louver assembly 120 and the outlet assembly 130 are disposed on opposite ends of the enclosure 110, with the louver assembly 120 disposed on the enclosure end wall 118 nearest the generator 210 and the outlet assembly 130 disposed on the enclosure end walls 118 nearest the engine 200. In other embodiments, the louver assembly 120 and the outlet assembly 130 can be provided in another location along the enclosure 110 (e.g., the enclosure roof 114 and/or the enclosure side walls 116). In some embodiments, the louver assembly 120 and the outlet assembly 130 can include louvers or other elements that allow air to enter the enclosure 110, while redirecting water (e.g., due to rainfall) and/or dust or other particles away from the enclosure 110 or to predefined drainage or collection areas of the enclosure 110. These predefined drainage and/or collection areas are disposed in positions determined to not impact operation of the DG set 100. Entry of dust into the enclosure 110 can lead to system failure of the DG set 100 and dust accumulation on the components housed in the enclosure 110. For example, if there is dust accumulation on an air intake of the engine 200, the engine 200 can intake air less efficiently, thereby limiting the operation of the engine 200 and the generator 210. Entry of water into the enclosure 110 can negatively impact the performance of the DG set 100. For example, upon substantial exposure to water, the operation of the generator 210 and/or the engine 200 can be limited and/or faulted (i.e., function derate). In some embodiments, the enclosure 110 includes collection and/or drainage areas disposed in the enclosure floor 112. In some embodiments, the collection and/or drainage areas are positioned proximate a corner of the internal volume of the enclosure 110 (e.g., the connection point between one of the enclosure side walls 116, one of the enclosure end walls 118, and the enclosure floor 112) wherein the corner is recessed such that collected water and dust contained in the water exits the enclosure 110.

In various embodiments, inner surfaces of the enclosure floor 112, the enclosure roof 114, the enclosure side walls 116, and the enclosure end walls 118 can be lined with acoustic dampening materials (e.g., acoustic material lining, etc.) structured to absorb and attenuate noise produced by the DG set 100. The noise can be generated by internal components such as the engine 200, the generator 210, or the like. Alternatively or in combination, the noise can be produced as a result of air flow passing through the enclosure 110 via the louver assembly 120 and the outlet assembly 130.

The louver assembly 120 is a ventilation air opening disposed at one of the enclosure end walls 118. As shown in FIGS. 1-2, the louver assembly 120 is mechanically connected to one of the enclosure end walls 118. In this manner, there is a plurality of openings formed on at least one side of the housing. In some embodiments, the plurality of louvers of the louver assembly 120 defines the plurality of openings on at least one side of the housing. In the embodiment of FIGS. 1-2, the louver assembly 120 is an air inlet assembly structured to reflect air proximate to the louver assembly 120 into the enclosure 110. In some embodiments, the louver assembly 120 is configured to deflect air as it moves into the enclosure 110. The outlet assembly 130 is mechanically coupled to the enclosure end wall 118 disposed on an opposite end of the enclosure 110 as the louver assembly 120. The outlet assembly 130 is an air outlet assembly structured to reflect air proximate to the outlet assembly 130 out of the enclosure 110. As shown in FIGS. 1-2, each of the louver assembly 120 and the outlet assembly 130 are coupled with the respective enclosure end walls 118 to be substantially flush with the enclosure end walls 118. In the embodiments of FIGS. 1-2, each of the louver assembly 120 and the outlet assembly 130 are coupled to the enclosure 110 at all edges of the louver assembly 120 and the outlet assembly 130. In some embodiments, the louver assembly 120 and the outlet assembly 130 can be coupled with the enclosure 110 via a fastener such that the outlet assembly 130 and the louver assembly 120 can be selectively removed from the enclosure 110. In other embodiments, the louver assembly 120 and the outlet assembly 130 can be hingedly coupled to the enclosure 110 such that the louver assembly 120 and the outlet assembly 130 can rotate about a connection point.

The louver assembly 120 can be made from metal such as aluminum, carbon steel, plastic, and/or another rigid material, or combination of materials. In some embodiments, the louver assembly 120 can be made from the same material as the enclosure 110, as described with reference to FIGS. 1-2 above. In some embodiments, the louver assembly 120 can be made from a material reflective to air.

The outlet assembly 130 can be made from a metal such as aluminum, carbon steel, plastic and/or another rigid material, or combination of materials. In some embodiments, the outlet assembly 130 can be made from the same material as the enclosure 110, as described with reference to FIGS. 1-2 above.

In some embodiments, the outlet assembly 130 and the louver assembly 120 can be made from the same material such that air exhibits substantially similar behavior at each of the louver assembly 120 and the outlet assembly 130. In other embodiments, the louver assembly 120 and the outlet assembly 130 can be made from different materials. For example, the louver assembly 120 can be made of a textured material so as to collect dust in the air entering the enclosure 110, while the outlet assembly 130 can be made of a smooth material to reduce friction experienced by the air exiting the enclosure 110.

In some embodiments, the DG set 100 can include an airflow system. As shown in FIGS. 1-2, the airflow system can include the enclosure 110, at least one opening on at least one side of the enclosure, and the louver assembly 120, wherein the louver assembly 120 is coupled to the at least one opening and configured to direct air into the enclosure 110.

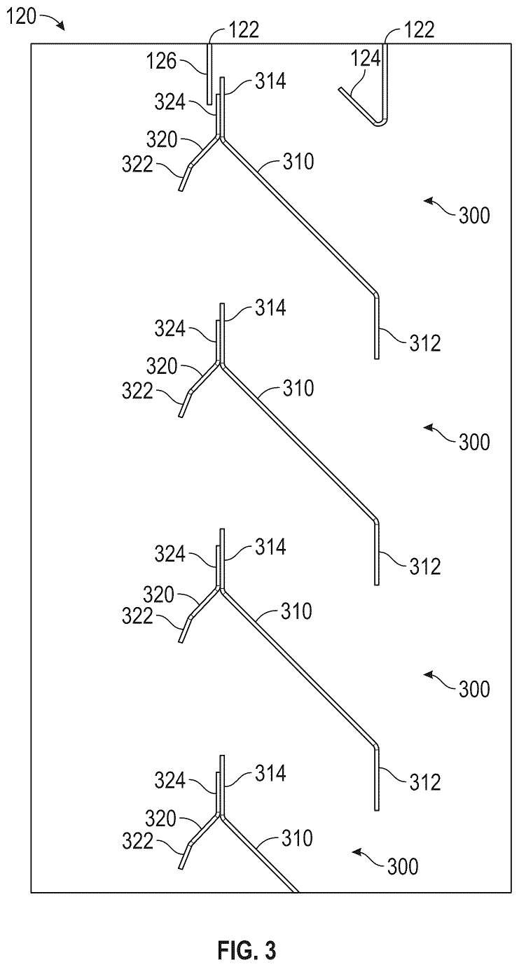

FIG. 3 is a side cross-sectional view of the louver assembly 120, according to an embodiment. The louver assembly 120 includes a top, shown as top of the louver assembly 122. The top of the louver assembly 122 includes a first leg 124 and a second leg 126. As shown in FIGS. 3-5, the first leg 124 is disposed proximate the outside of the enclosure 110, such that it interacts with the environment surrounding the enclosure 110. In some embodiments, the top of the louver assembly 122 is structured such that a vertical portion of the first leg 124 and the second leg 126 extend downward, substantially parallel to the enclosure end walls 118. As shown in FIG. 3, a portion the first leg 124 extends into the enclosure 110 at a substantially upward angle relative to the enclosure floor 112. In some embodiments, the vertical portion of the first leg 124 is configured such that it is substantially flush with the enclosure end walls 118 in which it is disposed. In this configuration, the top of the louver assembly 122 is positioned such that there are no large gaps between the louver assembly 120 and the enclosure end walls 118. In this manner, air entering the enclosure 110 must come into contact with the louver assembly 120 to enter the enclosure 110.

The louver assembly 120 includes one or more louver 300. As shown, each louver 300 extends into the enclosed space defined by the enclosure 110. In some embodiments, each louver 300 is structured to minimize the entry of dust into the enclosure. In some embodiments, each louver 300 of the louver assembly 120 is arranged such that it works in conjunction with at least one other louver 300 of the louver assembly 120 to restrict airflow and minimize dust entry into the enclosure 110. According to an example embodiment, each louver 300 is structured to collect dust entering the enclosure 110. In some embodiments, each louver 300 of the louver assembly 120 is coupled to a frame 128, such that each louver 300 of the louver assembly 120 is positioned in a substantially vertically linear configuration. In this manner, each louver 300 of the louver assembly 120 is vertically aligned with all the other louvers 300 of the louver assembly 120. In some embodiments, each louver 300 can be slidably coupled to the frame 128 such that each louver 300 can be vertically repositioned by the operator of the DG set 100. In this configuration, the operator of the DG set 100 can reposition any number of louvers 300 from outside or inside the enclosure 110. For example, upon determining that a temperature inside the enclosure 110 is above a target range, the operator can slide any number of louvers 300 of the louver assembly 120 vertically away from other louvers 300 of the louver assembly 120 to increase the amount of open surface area (i.e., surface area of the louver assembly 120 not occupied by a louver 300), thereby decreasing restriction of air entering the enclosure 110, increasing cooling air travelling through the enclosure 110. In some embodiments, the louver assembly 120 is adjustable to include any number of louvers 300 achieve at least one of a target airflow restriction value, a target temperature of the DG set 100, or a target open surface area of the louver assembly 120. In some embodiments, the distance between each louver 300 of the louver assembly 120 is adjustable to achieve at least one of a target airflow restriction value, a target temperature of the DG set 100, or a target open surface area of the louver assembly 120.

In some embodiments, each louver 300 is rotatably coupled to either side of the frame 128 such that the louver 300 can rotate about the connection point between the louver 300 and the frame 128. For example, upon determining that the engine 200 requires additional intake air, the operator can rotate any number of louvers 300 of the louver assembly 120 inwards towards the enclosure 110 to increase the amount of open surface area, thereby decreasing restriction of air entering the enclosure 110, increasing intake air for the engine 200.

In some embodiments, each louver 300 is movably and rotatably coupled to the frame 128 such that each louver 300 is movable and rotatable by the operator of the DG set 100. For example, upon determining that the DG set 100 requires more air entering the enclosure 110, an operator can slide any number of louvers 300 of the louver assembly 120 vertically away from other louver 300 of the louver assembly 120, and thereafter rotate any number of the louver 300 inwards towards the enclosure 110 to increase the amount of open surface area, thereby decreasing restriction of air entering the enclosure 110.

In some embodiments, each louver 300 can be made from metal such as aluminum, carbon steel, plastic, and/or another rigid material, or combination of materials. In some embodiments, each louver 300 can be made from the same material as the louver assembly 120. In some embodiments, each louver 300 can be made from the same material as the enclosure 110, as described with reference to FIGS. 1-2. In some embodiments, each louver 300 can be made from a material reflective to air.

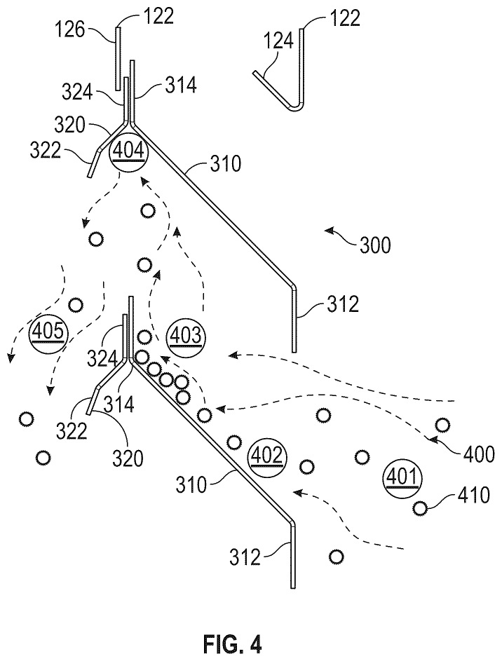

As shown in FIGS. 3-4, each louver 300 includes a first leg 310 and a second leg 320 coupled with the first leg 310. In some embodiments, each louver 300 is structured such that the first leg 310 is substantially longer than the second leg 320. In some embodiments, the first leg 310 and the second leg 320 are mechanically coupled (e.g., fused, welded, bonded with an adhesive product, etc.) such that the first leg 310 and the second leg 320 act as one member. In some embodiments, the first leg 310 and the second leg 320 are detachably coupled (e.g., coupled using magnets, coupled using a fastener, etc.) such that the second leg 320 can be selectively removed from the first leg 310, thereby decreasing the restriction of airflow entering the enclosure 110, thus promoting airflow to cool the DG set 100 and intake air for the engine 200. In some embodiments, the louver 300 can be integrally formed such that the first leg 310 and the second leg 320 are one component.

In some embodiments, each of the first leg 310 and the second leg 320 are made of the same material that the first leg 310 and the second leg 320 exhibit similar behavior, allowing for predictive projections and uniform air flow. In some embodiments, the first leg 310 and the second leg 320 may be made of different materials to behave differently from one another.

As shown in FIGS. 3-5, the first leg 310 includes a lower end 312 and an upper end 314. In some embodiments, the lower end 312 and the upper end 314 are substantially vertical and parallel to each other and the enclosure end walls 118. For example, the upper end 314 and the lower end 312 of the first leg extend vertically. As shown in FIGS. 3-4, the lower end 312 is positioned substantially flush to the vertical portion of the first leg 124, and thereby the enclosure end walls 118. In this manner, the first leg 310 is at least partially flush to a wall of the enclosure 110. For example, the lower end 312 is the outermost part of each louver 300 of the louver assembly 120, and the first component of the louver 300 to contact the environment surrounding the enclosure. In this example, air entering the enclosure 110 from the environment surrounding the enclosure via the louver assembly 120 will first contact the lower end 312 as it enters the enclosure 110. In some embodiments, a portion of the first leg 310 extends into the enclosure 110 at a substantially upward angle relative to the enclosure floor 112 between the lower end 312 and the upper end 314. For example, the first leg 310 at least partially extends at an upward angle to at least one side of the enclosure 110. This angled portion of the first leg 310 provides a location for accumulation and collection of dust and other particles contained in the air entering the enclosure 110. In this manner, each louver 300 is structured to collect dust entering the enclosure 110. In some embodiments, the louver assembly 120 is structured such that the angled portion of each first leg 310 is accessible from outside of the enclosure 110 allowing an operator to easily clean (e.g., remove dust, etc.) the louver 300.

Referring still to FIGS. 3-5, the first leg 310 has a top face. In some embodiments, the top face of the first leg 310 is configured to collect dust and redirect air. As air is redirected and its movement is restricted, dust in the air can settle. At the lower end 312, the top face of the first leg 310 redirects air entering the enclosure 110 outward, away from the enclosure 110. At the angled portion between the lower end 312 and the upper end 314, the top face of the first leg 310 redirects air entering the enclosure 110 upwards and away from the first leg 310. At the upper end 314, the top face of the first leg 310 redirects air upwards, away from the first leg 310. In some embodiments, the upper end 314 reflects air outwards, away from the enclosure 110. For example, as air enters the enclosure 110 and contacts the top face of the first leg 310, the air can be redirected upwards and outwards of the enclosure 110, substantially restricting the movement of the entering air. As the movement of the air is restricted, dust particles contained in the air can fall out of the air and settle on the top face of the first leg 310. In some embodiments, the top face of the first leg 310 is accessible from outside of the enclosure 110, such that the operator of the DG set 100 can remove the dust collected on the top face of the first leg 310 from outside of the enclosure 110. The first leg 310 has a bottom face. In some embodiments, the bottom face of the first leg 310 is configured to redirect dust and air entering the enclosure 110. At the lower end 312, the bottom face of the first leg 310 redirects air away from the first leg 310 into the enclosure 110. At the angled portion between the lower end 312 and the upper end 314, the bottom face of the first leg 310 redirects air entering the enclosure 110 downwards and into the enclosure 110. In this manner, each louver 300 is structured to direct air downwards. In some embodiments, at the upper end 314, the bottom face of the first leg 310 is coupled with the upper end 324 of the second leg 320.

Referring still to FIGS. 3-5, the second leg 320 includes a lower end 322 and an upper end 324. In some embodiments, the upper end 324 is substantially vertical and parallel with the lower end 312, the upper end 314, and the enclosure end walls 118. For example, the upper end 324 extends vertically. As shown in FIGS. 3-5, the upper end 314 of the first leg 310 is coupled with the upper end 324 of the second leg 320. In some embodiments, the upper end 324 is mechanically coupled with the upper end 314. In some embodiments, the upper end 324 is detachably coupled with the upper end 314.

In some embodiments, a portion of the second leg 320 extends into the enclosure 110 at a substantially downward angle relative to the enclosure roof 114 between the upper end 324 and the lower end 322. For example, the second leg 320 at least partially extends at a downward angle to at least one side of the enclosure 110. As shown in FIG. 3, the lower end 322 extends into the enclosure at a downward angle of larger magnitude than that of the angled portion between the upper end 324 and the lower end 322. In this manner, dust entering the enclosure 110 that contacts the lower end 322 is redirected towards the enclosure floor 112 to avoid substantially impacting the operation of the DG set 100. For example, the lower end 322 of the second leg 320 is structured to direct air downwards.

As shown in FIGS. 3-5, the second leg 320 has a bottom face. In some embodiments, the bottom face of the second leg 320 is configured to redirect air and dust entering the enclosure 110. At the upper end 324, the bottom face of the second leg 320 is coupled with the upper end 314 of the first leg 310. At the angled between the lower end 322 and the upper end 324, the bottom face of the second leg 320 redirects air downwards and away from the second leg 320. At the lower end 322, the bottom face of the second leg 320 reflects air downwards and into the enclosure 110. The second leg 320 has a top face. In some embodiments, the top face of the second leg 320 is configured to redirect dust falling in the enclosure 110 towards the predefined collection area in the enclosure floor 112. In some embodiments, the second leg 320 acts as a barrier between dust falling in the enclosure 110 and air entering the enclosure 110. In this manner, the falling dust is not carried further into the enclosure 110 by the entering air.

As shown in FIG. 3, the louver assembly 120 includes a plurality of louvers. In the configuration shown, there is a first louver 300 positioned near the top of the louver assembly 122, and a second louver 300 positioned below the first louver 300. In the embodiment shown, the lower end 312 of the first louver 300 extends vertically past the upper end 314 of the second louver 300, thereby preventing entering air from having a direct (i.e., unrestricted, etc.) path into the enclosure 110. The vertical orientation of the upper end 314 of the second louver 300 can prevent water or other liquids used in cleaning the louver assembly 120 from entering the enclosure 110. In some embodiments, each of the first louver 300 and the second louver 300 are configured to direct air at least partially towards the other of the first louver 300 and the second louver 300. For example, the louver assembly 120 includes a first louver and a second louver positioned below the first louver such that the first leg of the first louver extends vertically downward, at least partially past the first leg of the second louver, such that airflow is restricted.

Referring now to FIG. 4, a view of the first louver 300 and the second louver 300 is shown, according to an embodiment. As briefly disclosed above with reference to FIG. 3, a flow path 400 is shown. The flow path 400 is formed by the louver assembly 120 and causes dust in the air entering the enclosure to be collected before entering the enclosure 110. As shown in FIG. 4, the flow path 400 is an indication of the path in which air, and thereby, particles in the air (e.g., dust, etc.) enter the enclosure 110. The dotted lines of the flow path 400 represent the path of flow. FIG. 4 further includes multiple dust particles 410. The louver assembly 120 is structured such that air entering the enclosure 110 is reflected (e.g., redirected, etc.) upon contacting a louver 300 of the louver assembly 120. In this manner, the louver assembly 120 causes multiple redirections of the air entering the enclosure 110, thereby restricting air movement. The restriction of air movement causes particles in the air to settle (e.g., fall out of the air, etc.), preventing substantial amounts of the particles (e.g., dust) from entering the enclosure 110. For example, the louver assembly 120 is coupled to the enclosure 110, and is structured such that it forms the flow path 400 for air to be directed into the enclosure, wherein the louver assembly 120 is configured to deflect air as it moves into the enclosure 110.

As air first enters the enclosure 110, it travels around the lower end 312 of each of the first louver and the second louver 300, to a first location 401. Once proximate the first location 401, the air can travel towards the inside of the enclosure, where it can then reach a second location 402.

At the second location 402, the air and the dust particles 410 can contact the top face of the first leg 310 of the second louver 300. In some embodiments, the dust particles 410 will begin to accumulate on the first leg 310 at the second location 402. In some embodiments, the dust particles 410 will continue to travel into the enclosure 110, being redirected towards the bottom face of the first louver 300. In some embodiments, the dust particles 410 and the air will travel towards a third location 403.

As shown in FIG. 4, the third location 403 is defined by the upper end 314 of the second louver 300. At the third location 403, many dust particles 410 accumulate while air continues to be redirected. In some embodiments, the upper end 314 of the second louver 300 redirects the air and the dust particles 410 upwards and away from the second louver 300 towards the first louver 300 as shown by the flow path 400. In some embodiments the air and the dust particles 410 will travel towards a fourth location 404.

The fourth location 404 is defined by the connection point between the first leg 310 and the second leg 320 of the first louver 300. In some embodiments, the angle formed by the connection of the first leg 310 and the second leg 320 of the louver 300 defines the redirection caused at the fourth location 404. At the fourth location 404, air and the multiple dust particles 410 are redirected downwards and into the enclosure 110 as shown by the flow path 400. After arriving at the fourth location 404, the air and the dust particles 410 travel downward and into the enclosure 110. In some embodiments, the air and the dust particles 410 will travel towards a fifth location 405.

As shown in FIG. 4, the fifth location 405 is partially defined by the second leg 320 of the second louver 300. As shown by the first location 401, air and dust particles 410 at the fifth location 405 are directed downward and into the enclosure 110 by the second leg 320 of the second louver 300. The redirection by the second leg 320 of the second louver 300 can direct the air into the enclosure 110 and direct the dust particles 410 downwards and towards the predefined collection area inside of the enclosure 110. As shown in FIG. 4, the first louver 300 and the second louver 300 are constructed to direct air at least partially towards the other of the first louver 300 and the second louver 300.

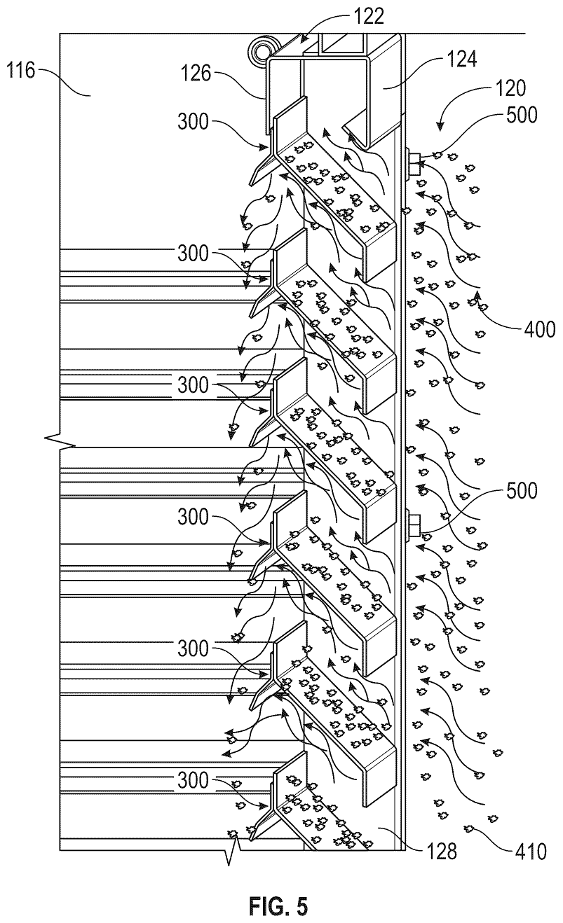

Referring now to FIG. 5, a perspective view of a portion of the louver assembly 120 is shown, according to an embodiment. The louver assembly 120 can include the frame 128. In some embodiments, the frame 128 includes the louver assembly 122. In some embodiments, the louver assembly 122 is structured to couple the louver assembly 120 with the enclosure 110. As shown in FIG. 5, the louver assembly 120 can include one or more fasteners 500 configured to couple the louver assembly 122 with the enclosure 110. In some embodiments, the louver assembly 122 and the enclosure end walls 118 can include a plurality of holes to receive the one or more one or more fasteners 500. As shown in FIG. 5, the top face of the first leg 310 of each louver 300 can collect the dust particles 410 entering the enclosure 110.

Various numerical values herein are provided for reference purposes only. Unless otherwise indicated, all numbers expressing quantities of properties, parameters, conditions, and so forth, used in the specification and claims are to be understood as being modified in all instances by the term “approximately.” Accordingly, unless indicated to the contrary, the numerical parameters set forth in the following specification and attached claims are approximations. Any numerical parameter should at least be construed in light of the number reported significant digits and by applying ordinary rounding techniques. The term “approximately” when used before a numerical designation, e.g., a quantity and/or an amount including range, in which may vary by (+) or (−) 10%, 5%, or 1%.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual leg.

It should be noted that the term “example” as used herein to describe various embodiments is intended to indicate that such embodiments are possible examples, representations, and/or illustrations of possible embodiments (and such term is not intended to connotate that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features describes and claimed without restricting the scope of these features to the precise numerical ranges provided. Accordingly, these terms should be interpreted as indicating that insubstantial or inconsequential modifications or alterations of the subject matter described and claimed (e.g., within plus or minus five percent of a given angle or other value) are considered to be within the scope of the invention as recited in the appended claims.

The terms “coupled,” “connected,” and the like as used herein mean the joining of to legs directly or indirectly to one another. Such joining may be stationary (e.g., permanent) or moveable (e.g., removable or releasable). Such joining may be achieved with the two legs of the two legs and any additional intermediate members being integrally formed as a single unitary body with one another or with the two legs of the two legs and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes, and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An enclosure for a genset, the enclosure comprising:
a housing defining an at least partially enclosed space;
a plurality of openings formed on at least one side of the housing; and
a plurality of louvers coupled to the at least one side of the housing, each of the louvers comprising:
a first leg including a vertical upper end and a vertical lower end; and
a second leg including a vertical upper end and a lower end, the vertical upper end of the second leg coupled with the vertical upper end of the first leg, wherein the lower end of the second leg is structured to direct air downwards.

2. The enclosure of claim 1, wherein the plurality of openings on the at least one side of the housing is defined by the plurality of louvers.

3. The enclosure of claim 1, wherein the enclosure comprises a floor defining an outer portion of the at least partially enclosed space away from a generator and an engine of the genset.

4. The enclosure of claim 1, wherein each louver includes a plurality of legs, each leg of the plurality of legs including a vertical upper end.

5. The enclosure of claim 1, wherein each louver at least partially extends upward at an angle relative to at least one side of the enclosure.

6. The enclosure of claim 1, wherein each louver at least partially extends downward at an angle relative to at least one side of the enclosure.

7. The enclosure of claim 1, wherein:
the plurality of louvers comprises a first louver and a second louver below the first louver; and
a first leg of the first louver extends vertically downward, at least partially past a first leg of the second louver, such that air flow is restricted from passing into the partially enclosed space.

8. The enclosure of claim 1, wherein a number of louvers of the plurality of louvers corresponds to a target amount of restriction of air flow by the plurality of louvers.

9. The enclosure of claim 1, wherein a distance between each louver of the plurality of louvers corresponds to a target amount of restriction of air flow by the plurality of louvers.

10. The enclosure of claim 1, wherein each louver of the plurality of louvers is vertically aligned with other louvers of the plurality of louvers.

11. The enclosure of claim 1, wherein each louver is at least partially flush to a wall of the enclosure.

12. The enclosure of claim 1, wherein each louver is structured to direct dust downwards towards a floor of the enclosure.

13. An airflow system for a genset, the airflow system comprising:
an enclosure;
at least one opening on at least one side of the enclosure; and
a louver assembly coupled to the enclosure at the at least one opening of the enclosure, the louver assembly forming multiple airflow paths to deflect airflow into the enclosure.

14. The airflow system of claim 13, wherein the louver assembly further comprises:
a first louver; and
a second louver positioned below the first louver, wherein each of the first louver and the second louver are structured to direct the airflow at least partially towards the other of the first and the second louver.

15. The airflow system of claim 13, wherein the louver assembly is structured such that the multiple airflow paths formed by the louver assembly cause dust in the air to settle on a surface of the louver assembly facing outward of the enclosure.

16. The airflow system of claim 13, wherein each louver includes a first leg and a second leg, and wherein the first leg is longer than the second leg and outward from the second leg relative to a space enclosed by the enclosure.

17. A diesel genset comprising:
an engine configured to provide mechanical power;
a generator configured to provide electrical power using the mechanical power from the engine;
an enclosure defining a space and a ventilation opening, the space at least partially enclosed by the enclosure and including an outer portion adjacent to the enclosure and an inner portion inward from the outer portion, the engine and the generator in the inner portion; and
a plurality of louvers disposed at the ventilation opening and extending into the enclosed space, each of the louvers structured to redirect air flow, from a first direction from outside the enclosed space towards the inner portion of the space, to at least one of a surface of one or more louvers of the plurality of louvers or to the outer portion of the space such that each dust contained in the air settles on each louver.

18. The diesel genset of claim 17, wherein each louver includes a first leg and a second leg, and an upper end of the first leg is attached to an upper end of the second leg.

19. The diesel genset of claim 17, wherein the surface faces outward from the enclosure to collect dust redirected by the plurality of louvers.

20. The diesel genset of claim 17, wherein the plurality of louvers directs air downward toward a floor of the enclosure.
